(19) United States
(12) Patent Application Publication
(10) Pub. No.: US 2013/0103907 A1
(43) Pub. Date: Apr. 25, 2013

(54) MEMORY MANAGEMENT DEVICE, MEMORY MANAGEMENT METHOD, CONTROL PROGRAM, AND RECORDING MEDIUM

(71) Applicant: Sony Corporation, Tokyo (JP)

(72) Inventors: Tomohiro Katori, Tokyo (JP); Kazumi Sato, Kanagawa (JP)

(73) Assignee: Sony Corporation, Tokyo (JP)

(21) Appl. No.: 13/650,668

(22) Filed: Oct. 12, 2012

(30) Foreign Application Priority Data
Oct. 19, 2011 (JP) 2011-229575

(51) Int. Cl. G06F 12/08

(52) U.S. Cl. 711/137; 711/E12.057

(57) ABSTRACT

A memory management device includes a prefetch execution unit which performs prefetching data from a first memory unit, and moving the data to a second memory unit, and an initial data preservation unit which preserves data including at least a part of the data items which are placed in the second memory unit before the prefetch execution unit performs the prefetching, and data including the data which is prefetched by the prefetch execution unit as initial data which is data stored in the second memory unit when a system including the first and second memory units is started, before the prefetch execution unit performs prefetching.

### BACKGROUND

The present technology relates to a memory management device, a memory management method, a control program, and a recording medium, and in particular, relates to a memory management device, a memory management method, a control program, and a recording medium in which starting of a system, and operations after the starting are speeded up.

In the related art, a method, which is referred to as a hibernation, is known in which, when a system is stopped, data in a main memory unit is evacuated to an auxiliary memory unit as is, and the system is operated in a state before stopping by reading out, and moving the data evacuated to the auxiliary memory unit to the main memory unit at the time of the subsequent starting.

In addition, in the related art, a method has been proposed (for example, refer to Japanese Unexamined Patent Application Publication No. 10-333997) in which processing of the hibernation is speeded up by reducing a data amount to be evacuated to the auxiliary memory unit from the main memory unit when stopping the system.

In addition, in the related art, a method has been proposed in which, when returning from the hibernation state, only an operating system (OS) on the main memory unit is returned to an execution state, and the OS transfers an image to the main memory unit from the auxiliary memory unit in each process, and then processes of which the transfer processing is completed restart running in order, thereby shortening a waiting time experienced by a user (refer to Japanese Unexamined Patent Application Publication No. 2010-250512).

In addition, in the related art, a method has been proposed, in which storage contents of the main memory unit immediately after a system initialization are stored in a hard disk drive as an initial start image, and initial start data is read out to the main memory unit from the hard disk drive when starting the system after the subsequent starting, thereby speeding up the starting of the system by using a hibernation function (refer to Japanese Unexamined Patent Application Publication No. 2004-38546).

### SUMMARY

However, in the technologies which are disclosed in Japanese Unexamined Patent Application Publication No. 10-333997, Japanese Unexamined Patent Application Publication No. 2010-250512, and Japanese Unexamined Patent Application Publication No. 2004-38546, since operations after starting a system are not particularly considered, when data which is necessary immediately after starting a system is not present in a main memory unit, it is necessary to read out the data from an auxiliary memory unit. As a result, there is a concern that operations of the system immediately after starting may slow down regardless of speeding up of starting of the system.

It is desirable to speed up starting of a system, and operations after the starting of the system.

According to an embodiment of the present technology, there is provided a memory management device which includes, a prefetch execution unit which performs prefetching of data from a first memory unit and moving the data to a second memory unit; and an initial data preservation unit which preserves data including at least a part of data items which are placed in the second memory unit before the prefetch execution unit performs the prefetching, and data including the data which is prefetched by the prefetch execution unit as initial data which is data stored in the second memory unit when a system including the first and second memory units is started, before the prefetch execution unit performs prefetching.

The prefetch execution unit may perform the prefetching when the system is stopped, and the initial data may include data which is stored in the second memory unit when stopping the system, and the data which is prefetched by the prefetch execution unit.

The prefetch execution unit may perform prefetching of data which is used in a function of executing the system after starting the system.

A predicting unit which predicts a function which is executed after starting the system is further provided, and the prefetch execution unit may perform prefetching of data which is used in a function which is predicted by the predicting unit.

The initial data preservation unit may preserve the initial data in the first memory unit, and a data reading-out unit which reads out the initial data, and move to the second memory unit from the first memory unit, when starting the system, may be further provided.

The initial data preservation unit may preserve the initial data in the second memory unit.

The prefetch execution unit may perform the prefetching after starting the system, the initial data preservation unit may preserve data including at least a part of data items which are stored in the second memory unit after starting the system, and data including the data which is prefetched by the prefetch execution unit as the initial data in the first memory unit, and a data reading-out unit which reads out and moves the initial data to the second memory unit from the first memory unit, when starting the system, may be further provided.

When the initial data is not preserved in the first memory unit, the initial data preservation unit may preserve at least a part of the data items which are preserved in the second memory unit after starting the system in the first memory unit as a first initial data, and when the first initial data is preserved in the first memory unit, and a second initial data is not preserved in the first memory unit, the prefetch execution unit may perform the prefetching after starting the system, and the initial data preservation unit may preserve data including the first initial data, and the data which is prefetched by the prefetch execution unit as the second initial data in the first memory unit.

The prefetch execution unit may further perform prefetching of data corresponding to a starting method of the system after reading out, and moving the initial data to the second memory unit.

The prefetch execution unit may perform prefetching of the data corresponding to a starting method of the system after starting the system, the initial data preservation unit may preserve the initial data which is different in each starting method of the system, and the data reading-out unit may read out, and move the initial data corresponding to the starting method of the system to the second memory unit from the first memory unit when starting the system.

The initial data preservation unit may perform updating of the initial data when a program of executing the system is changed.

According to another embodiment of the present technology, there is provided a memory management method which includes, prefetching data from a first memory unit and moving the data to a second memory unit, and preserving data including at least a part of data items which are stored in the second memory unit before performing the prefetching, and prefetched data as initial data which is data stored in the second memory unit when starting a system which includes the first and second memory units.

According to still another embodiment of the present technology, there is provided a control program which causes a computer to execute processing including, prefetching data from a first memory unit, and moving the data to a second memory unit, and preserving data including at least a part of data items which are stored in the second memory unit before performing the prefetching, and prefetched data as initial data which is data stored in the second memory unit when starting a system which includes the first and second memory units.

According to still another embodiment of the present technology, there is provided a recording medium on which the control program according to the above embodiment of the present technology is recorded.

According to the embodiments of the present technology, prefetching of data is performed from a first memory unit to a second memory unit, data including at least a part of data items which are stored in the second memory unit before performing the prefetching, and prefetched data are stored as initial data which is data preserved in the second memory unit when starting a system which includes the first and second memory units.

According to the embodiments of the present technology, it is possible to speed up starting of a system, and operation of the system after the starting.

### BRIEF DESCRIPTION OF THE DRAWINGS

FIG. 1 is a block diagram which shows a first embodiment of an information processing system to which the present technology is applied.

FIG. 2 is a flowchart which describes system stop processing which is executed by the information processing system in FIG. 1.

FIG. 3 is a flowchart which describes system return processing which is executed by the information processing system in FIG. 1.

FIG. 4 is a block diagram which shows a configuration example of a function when the information processing system in FIG. 1 is applied to a Blu-ray disk recorder.

FIG. 5 is a block diagram which shows a configuration example of a function when the information processing system in FIG. 1 is applied to a digital camera.

FIG. 6 is a block diagram which shows a first modification example according to the first embodiment of the information processing system to which the present technology is applied.

FIG. 7 is a block diagram which shows a second modification example according to the first embodiment of the information processing system to which the present technology is applied.

FIG. 8 is a block diagram which shows the second embodiment of the information processing system to which the present technology is applied.

FIG. 9 is a flowchart which describes system start processing which is executed by the information processing system in FIG. 8.

FIG. 10 is a block diagram which shows a configuration example of a function when the information processing system in FIG. 8 is applied to the Blu-ray disk recorder.

FIG. 11 is a block diagram which shows a configuration example of a function when the information processing system in FIG. 8 is applied to a tablet terminal.

FIG. 12 is a block diagram which shows a first modification example according to the second embodiment of the information processing system to which the present technology is applied.

FIG. 13 is a block diagram which shows a second modification example according to the second embodiment of the information processing system to which the present technology is applied.

FIG. 14 is a block diagram which shows a configuration example of a computer.

### DETAILED DESCRIPTION OF EMBODIMENTS

Hereinafter, embodiments for embodying the present technology (hereinafter, referred to as embodiments) will be described. In addition, descriptions will be made in the following order.

1. First embodiment (an example in which hibernation is performed)

2. First specific example of first embodiment (an example of applying the present technology to Blu-ray disk recorder)

3. Second specific example of first embodiment (an example of applying the present technology to digital camera)

4. First modification example of first embodiment (an example of using prefetch profile in a dividing manner)

5. Second modification example of first embodiment (an example of applying the present technology to a case where suspending is performed)

6. Second embodiment (an example of applying the present technology to a case where system is started using a start image)

7. First specific example of second embodiment (an example of applying the present technology to Blu-ray disk recorder)

8. Second specific example of second embodiment (example of applying the present technology to tablet terminal)

9. First modification example of second embodiment (example where prefetching is further performed in each use case after developing start image)

10. Second modification example of second embodiment (example where start image is used in a dividing manner in each use case)

11. Other modification examples

In addition, in the present specification, when the system is stopped so as to return the system to a state before stopping, it is referred to as stopping of the system, in particular. Here, the stopping of the system also includes a case where a part of a power supply of the system is turned off, and the system transits to an energy saving mode, only not completely turning off the power supply of the system. In addition, a state where the system is stopped is referred to as a stop state. Further, when the system is started from the stop state, and returns to a state before stopping, it is referred to as a return of the system, in particular.

1. First Embodiment

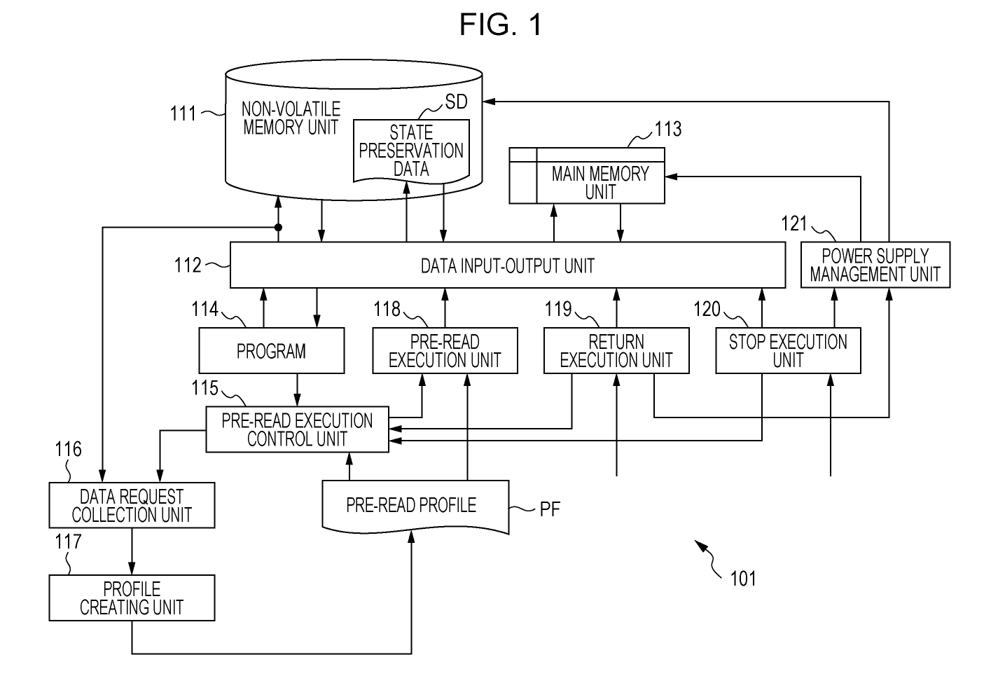

First, a first embodiment of the present technology will be described with reference to FIGS. 1 to 3. Configuration example of information processing system 101

FIG. 1 is a block diagram which shows a configuration example of a function of an information processing system 101 as the first embodiment of the present technology.

The information processing system 101 is configured by including a non-volatile memory unit 111, a data input-output unit 112, a main memory unit 113, a program 114, a prefetch execution control unit 115, a data request collection unit 116, a profile creating unit 117, a prefetch execution unit 118, a return execution unit 119, a stop execution unit 120, and a power supply management unit 121.

In addition, the data input-output unit 112, the prefetch execution control unit 115, the data request collection unit 116, the profile creating unit 117, the prefetch execution unit 118, the return execution unit 119, the stop execution unit 120, and the power supply management unit 121 are executed by, for example, an operating system which is executed by the information processing system 101.

In addition, as described later, in the information processing system 101, prefetching in which at least a part of data items which are necessary for executing the program 114 are read out to the main memory unit 113 from the non-volatile memory unit 111 before executing the program 114 is performed. Here, not only data which is used when processing the program 114, but also the program 114 itself is included as the target of the prefetching data.

The non-volatile memory unit 111 is used as an auxiliary memory unit, and stores permanent data such as a program, or a file having an executable format, and state preservation data SD.

The state preservation data SD is data which is preserved when the information processing system 101 is transited to the stop state, and is placed in the main memory unit 113 in order to return the information processing system to the state before stopping when the information processing system 101 is started from the stop state. The state preservation data SD includes the prefetched data which is read out from the non-volatile memory unit 111 by the prefetch execution unit 118, as described later, in addition to data which is evacuated from the main memory unit 113 when being transited to the stop state.

The data input-output unit 112 reads out data of the non-volatile memory unit 111 according to a request from the program 114, the prefetch execution unit 118, or the like, and transfers the data to a requester. In addition, the data input-output unit 112 stores the data which is read out from the non-volatile memory unit 111 to the main memory unit 113, reads out the data stored in the main memory unit 113, and transfer the data to the requestor when there is a request of reading out of the same data next time, in order to speed up the processing.

In addition, the data input-output unit 112 reads out data of the main memory unit 113, and stores in the non-volatile memory unit 111 according to a request from the stop execution unit 120, or the like, or as necessary.

The main memory unit 113 is a volatile memory unit, and is used as a work memory of the system. The main memory unit 113 includes, for example, a region in which data which is accessed among data items of the non-volatile memory unit 111, such as page cache which is managed by an operating system is temporarily preserved. The main memory unit 113 is configured by a memory unit of which the speed is higher than that of the non-volatile memory unit 111.

The program 114 is a program for executing a main function of the information processing system 101.

The prefetch execution control unit 115 creates a prefetch profile PF, and controls an execution of prefetching based on the prefetch profile PF. For example, the prefetch execution control unit 115 instructs the data request collection unit 116 to execute processing when creating the prefetch profile PF, and instructs the prefetch execution unit 118 to execute processing when the prefetching is executed.

The data request collection unit 116 monitors a data reading-out request to the non-volatile memory unit 111 which is issued from the data input-output unit 112 according to a request from the program 114 following an instruction of the prefetch execution control unit 115. In addition, the data request collection unit 116 collects a data request history as a history of the issued reading-out request, and supplies the history to a profile creating unit 117.

The profile creating unit 117 creates the prefetch profile PF based on the data request history which is collected by the data request collection unit 116.

The prefetch profile PF is data for instructing a prefetching order to the prefetch execution unit 118, and includes, for example, a position on the non-volatile memory unit 111, a size, and a prefetching order of data as a prefetch target.

The prefetch execution unit 118 performs prefetching of data based on the prefetch profile PF according to an instruction of the prefetch execution control unit 115. That is, the prefetch execution unit 118 reads out data which is necessary for the program 114 in the main memory unit 113 in advance by performing a data request to the data input-output unit 112. In this manner, it is possible to obtain data at high speed when the program 114 requests data in practice.

The return execution unit 119 performs a control of processing which returns the information processing system 101 from the stop state according to an instruction from the outside. For example, the return execution unit 119 turns power supplies of various units of the information processing system 101 on through the power supply management unit 121, and develops the state preservation data SD which is stored in the non-volatile memory unit 111 in the main memory unit 113 through the data input-output unit 112. In addition, the return execution unit 119 informs the prefetch execution control unit 115 that a return of the information processing system 101 has been instructed.

The stop execution unit 120 controls processing of stopping the information processing system 101 according to an instruction from the outside. For example, the stop execution unit 120 evacuates the state preservation data SD to the non-volatile memory unit 111 from the main memory unit 113 through the data input-output unit 112, and then turns off the power supplies of the various units of the information processing system 101 through the power supply management unit 121. In addition, the stop execution unit 120 informs the prefetch execution control unit 115 that a stop of the information processing system 101 has been instructed.

The power supply management unit 121 manages power supplies of the various units of the information processing system 101 including the non-volatile memory unit 111, and the main memory unit 113, and performs ON/OFF of the power supplies according to instructions of the return execution unit 119, the stop execution unit 120, or the like.

Stop Processing of System

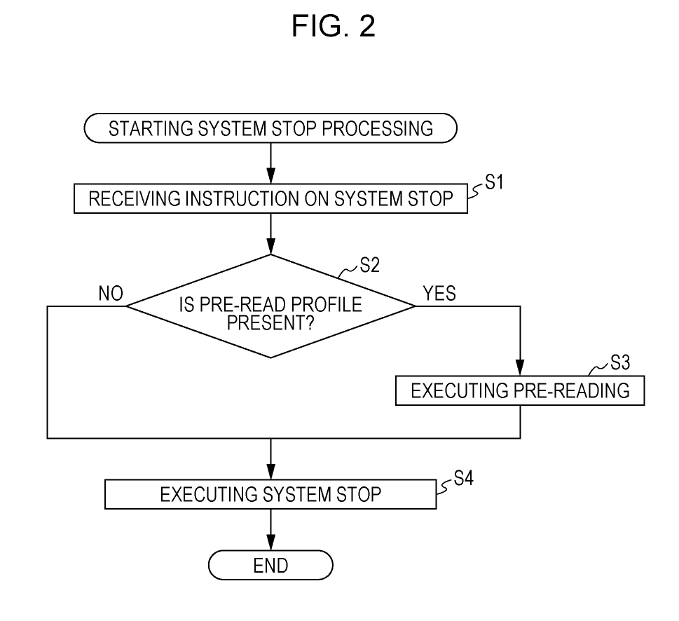

Subsequently, system stop processing which is executed by the information processing system 101 will be described with reference to the flowchart in FIG. 2.

In step S1, the stop execution unit 120 receives an instruction on stopping the system. For example, when a user operates an operation unit, which is not shown, while the information processing system 101 is operated, an instruction of stopping the information processing system 101 is input to the stop execution unit 120. The stop execution unit 120 informs the prefetch execution control unit 115 that the instruction of stopping the information processing system 101 has been made.

In step S2, the prefetch execution control unit 115 determines whether or not the prefetch profile PF is present. When it is determined that the prefetch profile PF is present, the process proceeds to step S3.

In step S3, the information processing system 101 executes the prefetching. Specifically, the prefetch execution control unit 115 instructs execution of the prefetching to the prefetch execution unit 118. The prefetch execution unit 118 requests data of the position and size which is denoted by the prefetch profile PF to the data input-output unit 112 in order. The data input-output unit 112 reads out the requested data from the non-volatile memory unit 111, and stores it in the main memory unit 113.

Thereafter, the process proceeds to step S4.

On the other hand, in step S2, when it is determined that the prefetch profile PF is not present, processing of step S3 is skipped, and the process proceeds to step S4.

In step S4, the information processing system 101 executes stopping of the system. Specifically, first, the stop execution unit 120 turns off the power supplies of the various units of the information processing system 101 through the power supply management unit 121. In addition, at this time, at least the power supplies of the non-volatile memory unit 111, and the main memory unit 113 are not turned off.

In addition, the stop execution unit 120 reads all data items of the main memory unit 113 out, through the data input-output unit 112, and stores the data in the non-volatile memory unit 111 as the state preservation data SD. In this manner, all of contents of the main memory unit 113 before stopping are preserved in the non-volatile memory unit 111.

Accordingly, when the prefetching is performed in step S3, the prefetched data which is prefetched from the non-volatile memory unit 111 is included in the state preservation data SD, in addition to the data which is stored in the main memory unit 113 when stopping the information processing system 101 (data which is stored in the main memory unit 113 before performing the prefetching).

Thereafter, the stop execution unit 120 turns the power supplies of the non-volatile memory unit 111, and the main memory 113 off through the power supply management unit 121, and the stopping processing of the system is completed.

Return Processing of System

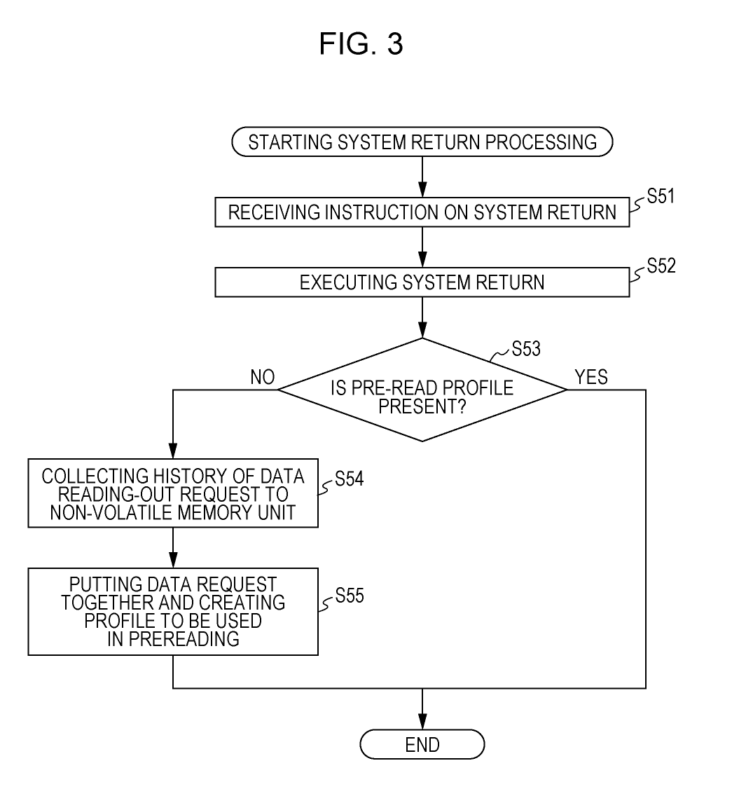

Subsequently, return processing of the system which is executed using the information processing system 101 will be described referring to the flowchart in FIG. 3.

In step S51, the return execution unit 119 receives an instruction of returning the system. For example, when a user operates the operation unit which is not shown while the information processing system 101 is stopped, an instruction of returning the information processing system 101 is input to the return execution unit 119. The return execution unit 119 informs the prefetch execution control unit 115 that the instruction of returning the information processing system 101 has been made.

In step S52, the information processing system 101 executes returning of the system. Specifically, the return execution unit 119 turns the power supplies of the various units of the information processing system 101 including the non-volatile memory unit 111 off and the main memory unit 113 through the power supply management unit 121.

Thereafter, the return execution unit 119 reads out the state preservation data SD which is stored in the non-volatile memory unit 111 through the data input-output unit 112, and develops the state preservation data in the main memory unit 113. In this manner, the contents of the main memory 113 becomes the state of before stopping, and the information processing system 101 returns to the state of before stopping from the stop state.

In step S53, the prefetch execution control unit 115 determines whether or not the prefetch profile PF is present. When it is determined that the prefetch profile PF is not present, the process proceeds to step S54.

In step S54, the data request collection unit 116 collects the history of data reading-out requests to the non-volatile memory unit 111. Specifically, the prefetch execution control unit 115 instructs the data request collection unit 116 to execute processing. The data request collection unit 116 monitors the data reading-out request to the non-volatile memory unit 111 which is issued from the data input-output unit 112 according to the request from the program 114, and collects the data request history.

In step S55, the profile creating unit 117 puts the data request history together, and creates the prefetch profile PF. Specifically, the profile creating unit 117 obtains the data request history from the data request collection unit 116, and extracts the reading-out position and size of the data which is recorded in the data request history, and is denoted in the reading-out request. In addition, the profile creating unit 117 creates the prefetch profile PF in which the extracted reading-out position and size are aligned in a predetermined order (for example, an order of reading-out). In addition, at this time, the profile creating unit 117 puts the data items of which the reading-out regions are close to each other together in one, or deletes repeated data items.

In addition, it is possible to arbitrarily set the range of performing prefetching of the program 114 as the target of the prefetch profile PF (hereinafter, refer to as a program to be prefetched), and the data on the basis of, for example, the specification, or performance of the information processing system 101, a capacity of the main memory unit 113, functions to be executed by the program 114, or the like.

For example, as the program to be prefetched, a program for executing a function, of which the possibility to be executed after starting the information processing system 101 is high, is selected. In addition, for example, data which is necessary until starting of the program to be prefetched is completed, data which is necessary for processing when executing the program to be prefetched, or data which is necessary for every process of the program to be prefetched are set as the range of performing the prefetching of data.

In addition, the system return processing is completed after creating the prefetch profile PF.

On the other hand, in step S53, when it is determined that the prefetch profile PF is present, processes of steps S54 and S55 are skipped, and the system return processing is completed without creating the prefetch profile PF.

As described above, when the information processing system 101 is returned, not only the data which is stored in the main memory unit 113 at the time of stopping, but also the prefetched data is placed in the main memory unit 113. Accordingly, it is also possible to speed up the operation of the information processing system after returning (more specifically, the operation of the function which is executed using the program to be prefetched), not only to speed up returning of the information processing system 101.

2. First Specific Example of First Embodiment

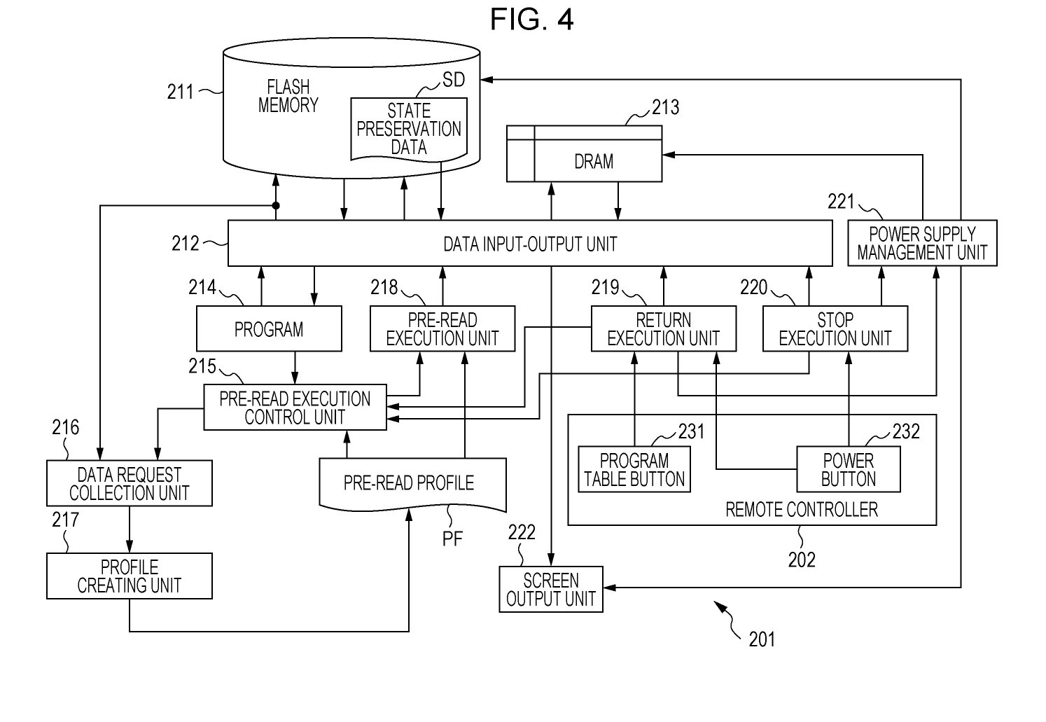

FIG. 4 is a block diagram which shows a configuration example of a function when applying the information processing system 101 to a Blu-ray disk recorder, as a first specific example of the information processing system 101.

In addition, FIG. 4 mainly shows a portion relating to the present technology among constituent elements of a Blu-ray disk recorder 201, and a part thereof is not shown. In addition, in the figure, portions corresponding to FIG. 1 are given with the same two-digit numbers from below as those in FIG. 1, and portions having the same processing are appropriately omitted, since descriptions thereof are repeated.

In the Blu-ray disk recorder 201, a flash memory 211 is adopted as a specific example of a non-volatile memory unit 111 of the information processing system 101 in FIG. 1, and a DRAM (Dynamic Random Access Memory) 213 is adopted as a specific example of a main memory unit 113. In addition, a screen output unit 222 which outputs data for displaying a reproduction screen, or an operation screen to an external display or the like is added to the Blu-ray disk recorder.

In addition, a remote controller 202 for operating the Blu-ray disk recorder 201 is added thereto. The remote controller 202 is provided with at least a program table button 231 for displaying the program table, and a power button 232 for operating a power supply of the Blu-ray disk recorder 201.

For example, if a user operates the program table button 231 of the remote controller 202 when the power supply of the Blu-ray disk recorder 201 is turned off, the program table is displayed on the external display after the power supply of the Blu-ray disk recorder 201 is turned on. Here, it is possible to speed up the display of the program table, immediately after starting the Blu-ray disk recorder 201 by applying the present technology thereto.

Specifically, when a user first operates the program table button 231, and starts the Blu-ray disk recorder 201, a data request collection unit 216 monitors a data reading-out request from a flash memory 211 which is issued from a data input-output unit 212, and collects a data request history according to an instruction of a prefetch execution control unit 215. A profile creating unit 217 creates a prefetch profile PF based on the collected data request history.

In addition, it is preferable to create the prefetch profile PF in advance when delivering the Blu-ray disk recorder 201.

Subsequently, when a user operates the power button 232, and turns off the power supply of the Blu-ray disk recorder 201, a stop execution unit 220 turns off the power supply of a screen output unit 222, first, through a power supply management unit 221. In this manner, the Blu-ray disk recorder 201 is in the turned-off state when seen by a user.

In addition, a prefetch execution unit 218 executes prefetching in the background based on the prefetch profile PF according to an instruction of a prefetch execution control unit 215. In this manner, data which is necessary for operating a program table function is read out from the flash memory 211, and is stored in a DRAM 213.

Further, the stop execution unit 220 preserves all of the data items which are stored in the DRAM 213 in the flash memory 211 as state preservation data SD through the data input-output unit 212. Accordingly, data which is necessary for operating the program table function is included in the state preservation data SD, in addition to data of the DRAM 213 before turning off the power supply. Thereafter, the stop execution unit 220 turns the power supply of the flash memory 211, and the DRAM 213 off through the power supply management unit 221.

Subsequently, when a user operates the program table button 231, and the power supply of the Blu-ray disk recorder 201 is turned on, a return execution unit 219 turns power supplies of various units of the Blu-ray disk recorder 201 including the flash memory 211, the DRAM 213, and the screen output unit 222 through the power supply management unit 221 on.

Thereafter, the return execution unit 219 controls the data input-output unit 212, reads out the state preservation data SD from the flash memory 211, and develops the state preservation data in the DRAM 213. In addition, at the time of completing developing of the state preservation data SD, the operation of the program table function is started.

At this time, the data which is necessary for operating the program table function is read out to the DRAM 213 in advance, accordingly, it is not necessary to newly read out the data from the flash memory 211. Accordingly, it is possible to operate the program table function at high speed immediately after starting the Blu-ray disk recorder 201.

3. Second Specific Example of First Embodiment

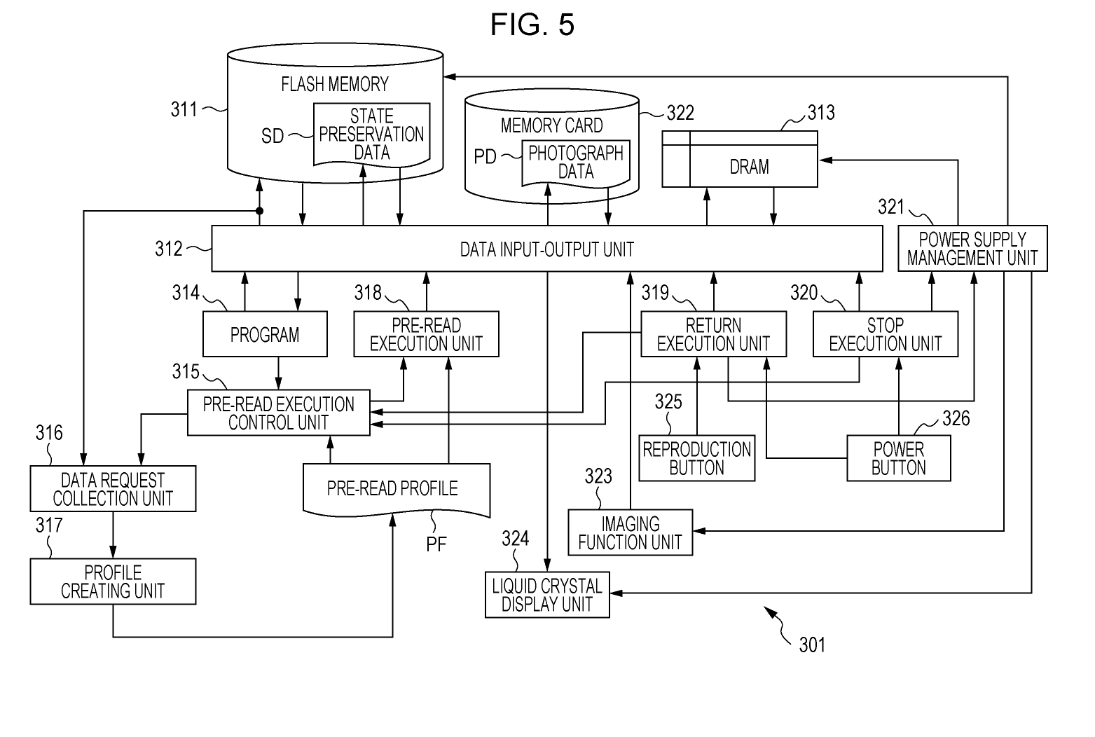

FIG. 5 is a block diagram which shows a configuration example of a function when the information processing system 101 is applied to a digital camera as a second specific example of the information processing system 101.

In addition, FIG. 5 mainly shows portions relating to the present technology among constituent elements of a digital camera 301, and a part thereof is not shown. In addition, in the figure, portions corresponding to FIG. 1 are given with the same two-digit numbers from below as those in FIG. 1, and portions having the same processing are appropriately omitted, since descriptions thereof are repeated.

In the digital camera 301, a built-in flash memory 311 is adopted as a specific example of a non-volatile memory unit 111 of the information processing system 101 in FIG. 1, and a DRAM (Dynamic Random Access Memory) 313 is adopted as a specific example of a main memory unit 113. In addition, a memory card 322, an imaging function unit 323, a liquid crystal display unit 324, a reproduction button 325, and a power button 326 are added thereto.

The memory card 322 is a storage medium which stores photograph data PD which is photographed by the imaging function unit 323. Reading and writing of the photograph data PD with respect to the memory card 322 is performed by a data input-output unit 312.

The imaging function unit 323 includes an image sensor, a lens, or the like, and executes a function of photographing. The imaging function unit 323 supplies the photograph data PD which is obtained as a result of the photographing to the data input-output unit 312.

The liquid crystal display unit 324 displays the photograph data PD, and an operation screen, a setting screen, or the like of the digital camera 301 on the basis of the data which is supplied from the data input-output unit 312.

The reproduction button 325 is a button for performing a reproduction of the photograph data PD which is stored in the memory card 322. When the reproduction button 325 is operated, an operation signal is supplied to a return execution unit 319.

The power button 326 is a button for operating a power supply of the digital camera 301. When the power button 326 is operated to be turned on, an operation signal is supplied to the return execution unit 319, and when the power button is operated to be turned off, the operation signal is supplied to the stop execution unit 320.

For example, when the power supply of the digital camera 301 is turned off, and a user operates the reproduction button 325, the reproduction of the photograph data PD is started after the power supply of the digital camera 301 is turned on. Here, it is possible to speed up the reproduction of the photograph data PD immediately after starting the digital camera 301 by applying the present technology.

Specifically, when a user first operates the reproduction button 325, and starts the digital camera 301, a data request collection unit 316 monitors a data reading-out request from a flash memory 311 which is issued from a data input-output unit 312 according to an instruction of a prefetch execution unit 315, and collects a data request history. A profile creating unit 317 creates the prefetch profile PF based on the collected data request history. In addition, it is preferable to create the prefetch profile PF in advance when delivering the digital camera 301.

Subsequently, when a user operates the power button 326, and turns off the power supply of the digital camera 301, the stop execution unit 320 turns off the power supplies of the imaging function unit 323 and the liquid crystal display unit 324, first, through a power supply management unit 321. The power supply of the digital camera 301 is in the turned-off state when seen by a user.

In addition, a prefetch execution unit 318 executes prefetching in the background based on the prefetch profile PF according to an instruction of a prefetch execution unit 315. In this manner, data which is necessary for operating a reproduction function of the photograph data PD is read out from the flash memory 311, and is stored in a DRAM 313. In addition, the latest photograph data PD which is photographed last is read out from the memory card 322, and is stored on the DRAM 313.

Further, the stop execution unit 320 preserves all of the data items which are stored in the DRAM 313 in the flash memory 311 as state preservation data SD through the data input-output unit 312. Accordingly, data which is necessary for operating the reproduction function of the photograph data PD, and the latest photograph data PD are included in the state preservation data SD, in addition to the data of the DRAM 313 immediately before turning off the power supply. Thereafter, the stop execution unit 320 turns off the power supplies of the flash memory 311 and the DRAM 313 through the power supply management unit 321.

Subsequently, when a user turns on the power supply of the digital camera 301 by operating the reproduction button 325, a return execution unit 319 turns on the power supplies of various units of the digital camera including the flash memory 311, the DRAM 313, the imaging function unit 323, and the liquid crystal display unit 324 through the power management unit 321.

Thereafter, the return execution unit 319 reads out the state preservation data SD from the flash memory 311 through the data input-output unit 312, and develops the state preservation data in the DRAM 313. In addition, the reproduction of the photograph data PD is started at the time of completing developing of the state preservation data SD.

At this time, data which is necessary for operating the reproduction function of the photograph PD is read out previously in the DRAM 313, accordingly, it is not necessary to newly read out the data from the flash memory 311. In addition, the first reproduced latest photograph data PD is also read out to the DRAM 313. Accordingly, it is possible to perform the reproduction of the photograph data PD at high speed immediately after starting the digital camera 301.

4. First Modification Example of First Embodiment

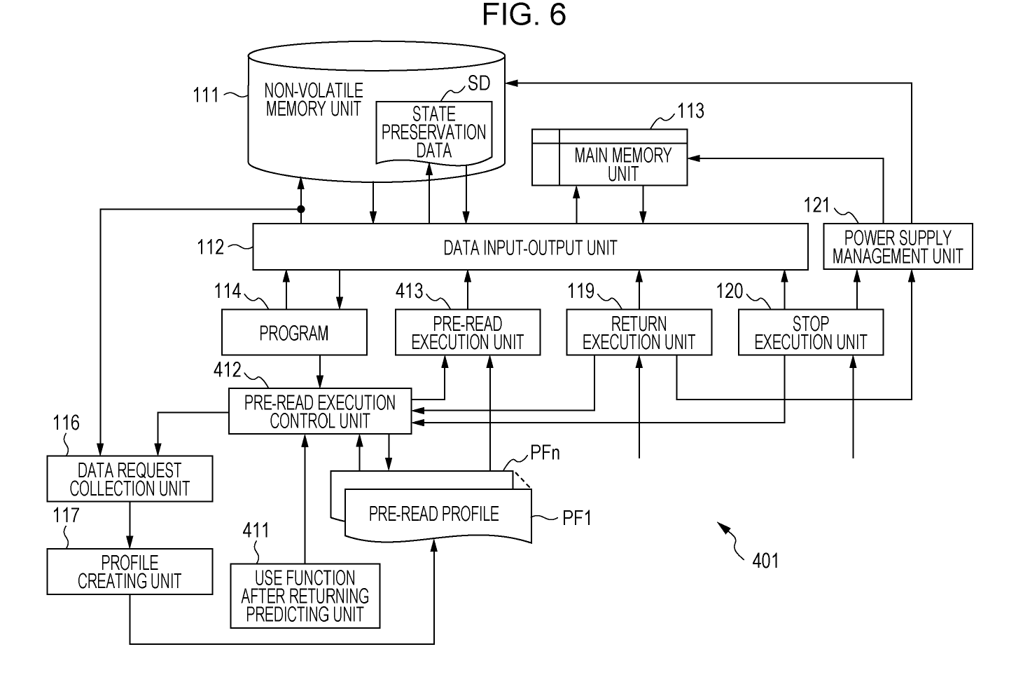

FIG. 6 is a block diagram which shows a configuration example of an information processing system 401 as a first modification example of the information processing system 101. The first modification example is an example in which respective functions can be performed at high speed when there is a plurality of candidate functions to be executed immediately after returning.

In addition, in the figure, portions corresponding to those in FIG. 1 are given with the same reference numerals, and portions having the same processing are appropriately omitted, since descriptions thereof are repeated.

An information processing system 401 is added with a use function after returning predicting unit 411 compared to the information processing system 101, and is different from the information processing system 101 by being provided with a prefetch execution control unit 412, and a prefetch execution unit 413, instead of the prefetch execution control unit 115, and the prefetch execution unit 118.

The use function after returning predicting unit 411 learns a use state of the information processing system 401 by a user, and predicts a function to be executed in the subsequent return on the basis of a learned result, when the information processing system 401 is stopped. In addition, the use function after returning predicting unit 411 supplies the predicted result to the prefetch execution control unit 412.

The prefetch execution control unit 412 instructs a data request collection unit 116 to collect histories of data requests which are different from each other in each function which is executed immediately after the information processing system 401 is returned. A profile creating unit 117 creates prefetch profiles PF1 to PFn which are different from each other in each function which is executed immediately after returning of the information processing system 401.

In addition, the prefetch execution control unit 412 selects an appropriate prefetch profile among the prefetch profiles PF1 to PFn on the basis of the predicting result of the use function after returning predicting unit 411 when the information processing system 401 is stopped. Then, the prefetch execution control unit 412 allows the prefetch execution unit 413 to perform prefetching based on the selected prefetching profile.

In this manner, prefetched data with respect to a function which is predicted to be executed in the subsequent return is included in state preservation data SD. Accordingly, it is possible to operate the functions at high speed immediately after the information processing system 401 is returned, even when there is a plurality of candidate functions to be executed immediately after the information processing system 401 is returned.

5. Second Modification Example of First Embodiment

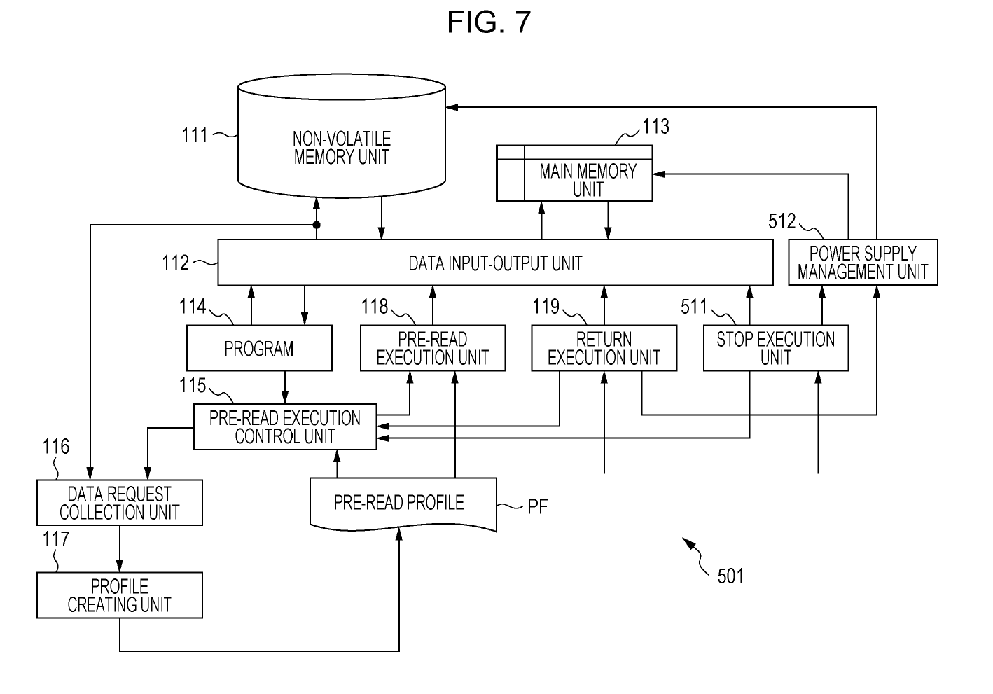

FIG. 7 is a block diagram which shows a configuration example of an information processing system 501 as a second modification example of the information processing system 101. The second modification example is an example to which the present technology is applied when suspending of a system is performed.

In addition, in the figure, portions corresponding to those in FIG. 1 are given with the same reference numerals, and portions having the same processing are appropriately omitted, since descriptions thereof are repeated.

An information processing system 501 is different from the information processing system 101 by being provided with a stop execution unit 511, and a power supply management unit 512 instead of the stop execution unit 120, and the power supply management unit 121 compared to the information processing system 101.

The stop execution unit 511 is different from the stop execution unit 120 in FIG. 1 by not evacuating the data in a main memory unit 113 to a non-volatile memory unit 111 when a power supply of the information processing system 501 is turned off.

The power supply management unit 512 is different from the power supply management unit 121 in FIG. 1 by preserving data in the main memory unit 113 while causing the main memory unit 113 to be electrically connected, when the power supply of the information processing system 501 is turned off.

Accordingly, data corresponding to the state preservation data SD in FIG. 1 is preserved in the main memory unit 113 as is when the information processing system 501 is in a stop state. Accordingly, when returning the information processing system 501 in the next time, the data is placed in the main memory unit 113 in advance, and it is not necessary to read out the data in the main memory unit 113 from the non-volatile memory unit 111, accordingly, it is possible to perform starting of the information processing system 501 at high speed. In addition, it is possible to speed up operations after starting, similarly to the information processing system 101.

6. Second Embodiment

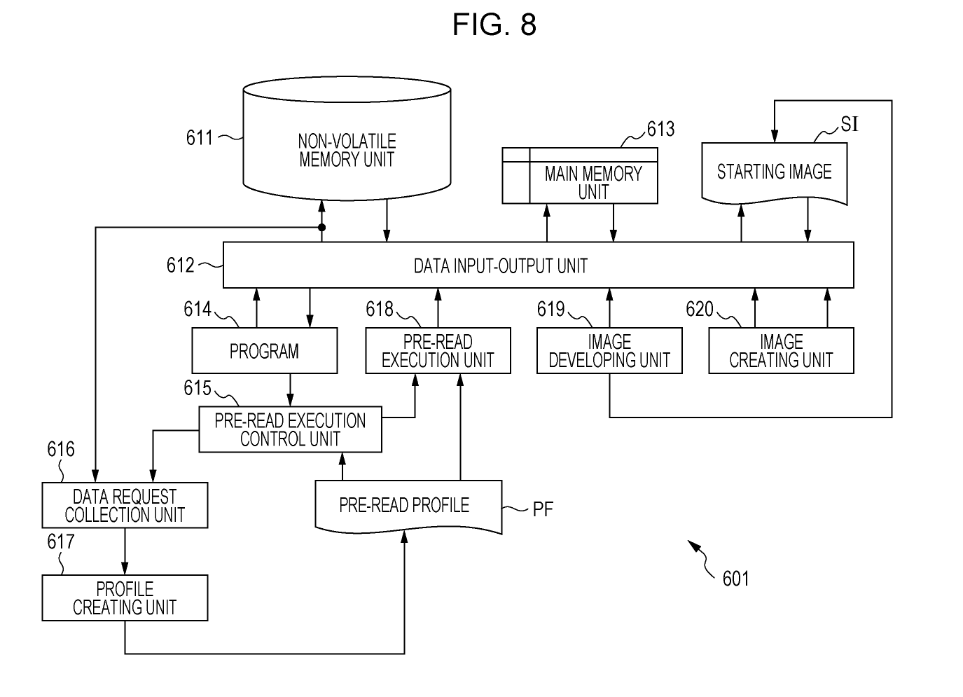

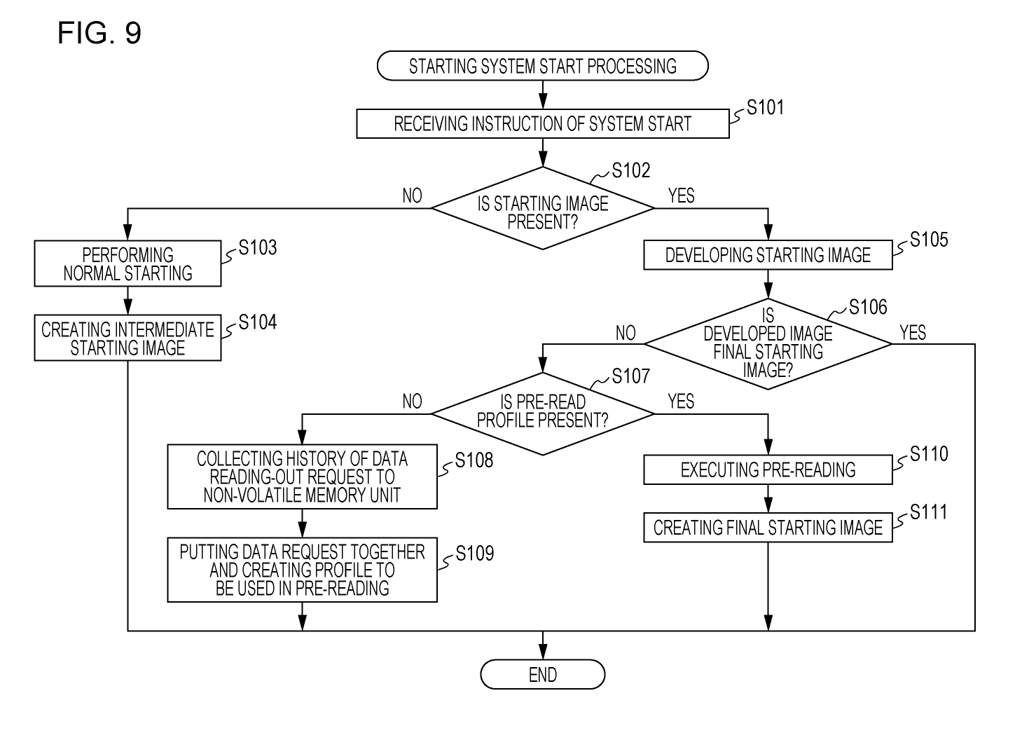

Subsequently, a second embodiment of the present technology will be described with reference to FIGS. 8 and 9. The second embodiment of the present technology is an embodiment to which the present technology is applied when performing starting of a system using a starting image.

Configuration Example of Information Processing System 601

FIG. 8 is a block diagram which shows a configuration example of a function of an information processing system 601 as the second embodiment of the present technology.

The information processing system 601 is configured by including a non-volatile memory unit 611, a data input-output unit 612, a main memory unit 613, a program 614, a prefetch execution control unit 615, a data request collection unit 616, a profile creating unit 617, a prefetch execution unit 618, an image developing unit 619, and an image creating unit 620.

In addition, the data input-output unit 612, the prefetch execution control unit 615, the data request collection unit 616, the profile creating unit 617, the prefetch execution unit 618, the image developing unit 619, and the image creating unit 620 are executed, for example, by an operating system which is executed in the information processing system 601.

In addition, in the information processing system 601, prefetching in which at least a part of the data items which are necessary to execute the program 614 is read out to the main memory unit 613 from the non-volatile memory unit 611 is performed before executing the program 614, similarly to the information processing system 101.

The non-volatile memory unit 611 stores permanent data such as a program, or a file having an executable format, and a starting image SI.

The starting image SI is data in which a state of the information processing system 601 at a certain time (for example, the initial state) is preserved, and includes at least a part of data items of the main memory unit 613 at the time point. In addition, the starting image SI is placed in the main memory unit 613 in order to be set to the state when the information processing system 601 is started. In addition, as described later, there are two types of images of an intermediate starting image, and a final starting image in the starting image SI.

The data input-output unit 612 reads out data of the non-volatile memory unit 611 according to a request from the program 614, the prefetch execution unit 618, and the image developing unit 619, and delivers the data to requestors. In addition, the data input-output unit 612 stores the data read out from the non-volatile memory unit 611 in the main memory unit 613 in order to speed up processing, and reads out the data stored in the main memory unit 613, and delivers the data to the requestors, when a request of reading out the same data request is made in the next time.

In addition, the data input-output unit 612 reads out the data in the main memory unit 613, and stores in the non-volatile memory unit 611 according to a request from the image creating unit 620 or the like, or as necessary.

The main memory unit 613 is a volatile memory unit, and is used as a work memory of the system. For example, the main memory unit 613 includes a region in which data which is accessed among data items of the non-volatile memory unit 611, such as page cache which is managed by an operating system is temporarily preserved. The main memory unit 613 is configured by a memory unit of which speed is higher than that of the non-volatile memory unit 611.

The program 614 is a program for executing a main function of the information processing system 601.

The prefetch execution control unit 615 performs a control of creating a prefetch profile PF, and executing of the prefetching based on the prefetch profile PF. For example, the prefetch execution control unit 615 instructs the data request collection unit 616 to execute processing when creating the prefetch profile PF, and instructs the prefetch execution unit 618 to execute processing when the prefetching is executed.

The data request collection unit 616 monitors a data reading-out request with respect to the non-volatile memory unit 611 which is issued from a data input-output unit 612 according to a request from the program 614 according to an instruction of the prefetch execution control unit 615. In addition, the data request collection unit 616 collects a data request history as a history of reading-out request which is issued, and supplies the history to the profile creating unit 617.

The profile creating unit 617 creates the prefetch profile PF on the basis of the data request history which is collected by the data request collection unit 616.

The prefetch profile PF is data which instructs the prefetch execution unit 618 of a prefetching order, and the data includes a position on the non-volatile memory unit 611, a size, and an order of prefetching of the data to be prefetched.

The prefetch execution unit 618 performs the prefetching of data based on the prefetch profile PF according to the instruction of the prefetch execution control unit 615. That is, the prefetch execution unit 618 reads out the data which is necessary for the program 614 in advance in the main memory unit 613 by performing the data request with respect to the data input-output unit 612. In this manner, it is possible to obtain data at high speed when the program 614 requests the data in practice.

The image developing unit 619 reads out the starting image SI from the non-volatile memory unit 611 through the data input-output unit 612, and develops the starting image in the main memory unit 613.

The image creating unit 620 creates the starting image SI through the data input-output unit 612, and stores the starting image in the non-volatile memory unit 611.

System Starting Processing

Subsequently, system starting processing which is executed by the information processing system 601 will be described with reference to the flowchart in FIG. 9.

In step S101, the information processing system 601 receives an instruction of starting the system. For example, when a user operates an operation unit, which is not shown, while stopping the information processing system 601, the instruction of starting the information processing system 601 is input to the prefetch execution control unit 615, the image developing unit 619, the image creating unit 620, or the like.

In step S102, the image developing unit 619 determines whether or not the starting image SI is present. When it is determined that the starting image SI is not present, that is, when it is determined that neither the intermediate starting image nor the final starting image is present, the process proceeds to step S103.

In step S103, the information processing system 601 is normally started. In addition, the information processing system 601 is set to the normal initial state.

In step S104, the image creating unit 620 creates the intermediate starting image. Specifically, the image creating unit 620 creates the intermediate starting image by deleting data which is not necessary to preserve from data items in the main memory unit 613 at the time point. Here, the data which is not necessary to preserve is, for example, data which can be easily restored from data which is stored in the non-volatile memory unit 611, data which is not necessary for starting the information processing system 601, or the like.

In this manner, by deleting the data which it is not necessary to preserve, it is possible to make the size of the intermediate starting image small. In addition, the intermediate starting image is assumed to be configured by data which is necessary for setting the information processing system 601 to a predetermined state (for example, the initial state) when starting the information processing system 601, and is not easy to restore.

In addition, the image creating unit 620 stores the created intermediate starting image in the non-volatile memory unit 611 through the data input-output unit 612.

Thereafter, the system starting processing is completed.

On the other hand, in step 5102, when it is determined that the starting image SI is present, that is, it is determined that the intermediate starting image, or the final starting image is present, the process proceeds to step S105.

In step S105, the image developing unit 619 develops the starting image SI. That is, the image developing unit 619 reads out the starting image SI from the non-volatile memory unit 611 through the data input-output unit 612, and develops the starting image in the main memory unit 613.

In step S106, the image developing unit 619 determines whether or not the developed starting image SI is the final starting image. When the developed starting image SI is determined as the intermediate starting image, not the final starting image (that is, the intermediate starting image is preserved in the non-volatile memory 611, and the final starting image is not preserved in the non-volatile memory 611), the process proceeds to step 5107.

In step S107, the prefetch execution control unit 615 determines whether or not the prefetch profile PF is present. When it is determined that the prefetch profile PF is not present, the process proceeds to step S108.

In step S108, the data request collection unit 616 collects the history of data reading-out request with respect to the non-volatile memory unit 611. Specifically, the prefetch execution control unit 615 instructs the data request collection unit 616 to execute processing. The data request collection unit 616 monitors the data reading-out request with respect to the non-volatile memory unit 611 which is issued from the data input-output unit 612 according to the request from the program 614, and collects the data request history.

In step S109, the profile creating unit 617 puts the data request history together, and creates the prefetch profile PF. Specifically, the profile creating unit 617 obtains the data request history from the data request collection unit 616, and extracts a reading-out position and a size of the data denoted in the reading-out request which is recorded in the data request history. In addition, the profile creating unit 617 creates the prefetch profile PF in which the extracted reading-out position and size are aligned in a predetermined order (for example, a reading-out order). In addition, at this time, the profile creating unit 617 puts the data items of which the reading-out regions are close to each other together in one, or deletes repeated data items.

In addition, the program 614 as a target of the prefetch profile PF (that is, a program to be prefetched), and the range of performing the prefetching, for example, can be arbitrarily set on the basis of the specification, or a performance of the information processing system 601, a capacity of the main memory unit 613, functions to be executed by the program 614, or the like.

For example, as the program to be prefetched, a program for executing a function of which a possibility to be executed after starting the information processing system 601 is high is selected. In addition, as a range of performing the data prefetching, for example, data which is necessary until completing starting of the program to be prefetched, data which is necessary for a process when executing the program to be prefetched, or data which is necessary for every process of the program to be prefetched are set.

In addition, the system starting processing is completed after creating the prefetch profile PF.

On the other hand, in step S107, when it is determined that the prefetch profile PF is present, the process proceeds to step S110.

In step S110, the information processing system 601 executes the prefetching. Specifically, the prefetch execution control unit 615 instructs the prefetch execution unit 618 to execute the prefetching. The prefetch execution unit 618 requests data of the position and the size which are denoted by the prefetch profile PF with respect to the data input-output unit 612 in order. The data input-output unit 612 reads out the requested data from the non-volatile memory unit 611, and stores the data in the main memory unit 613.

In step S111, the image creating unit 620 creates the final starting image. Specifically, the image creating unit 620 sets data of the main memory unit 613 at this time point, that is, data in which data which is prefetched based on the prefetch profile PF is added to the intermediate starting image which is stored in the main memory unit 613 before performing the prefetching as the final starting image. In addition, the image creating unit 620 stores the final starting image in the non-volatile memory unit 611 through the data input-output unit 112.

Thereafter, the system starting processing is completed.

On the other hand, in step 5106, when it is determined that the developed starting image is the final starting image, the system starting processing is completed.

As described above, when starting the information processing system 601, it is possible to set the information processing system 601 to a predetermined state rapidly using the intermediate starting image among the final starting images. In addition, when starting the information processing system 601, the prefetched data is also placed in the main memory unit 613, not only the intermediate starting image. Accordingly, it is also possible to speed up the operation after starting (more specifically, operation of a function which is executed by the program to be prefetched), not only speed up the starting of the information processing system 601.

7. First Specific Example of Second Embodiment

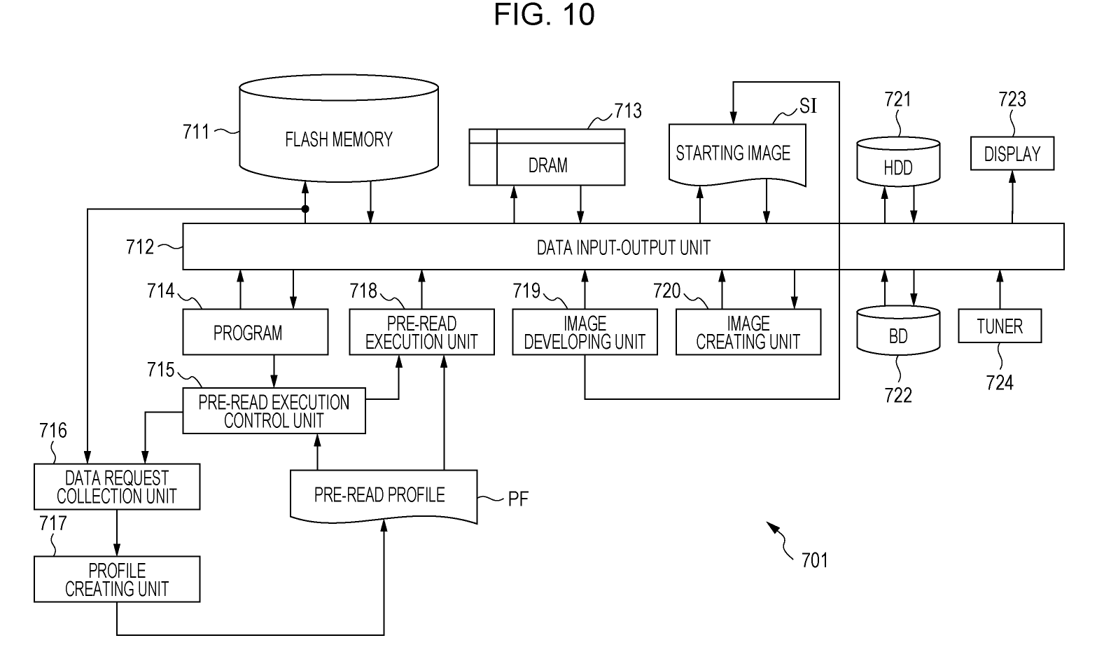

FIG. 10 is a block diagram which shows a configuration example of a function when the information processing system 601 is applied to a Blu-ray disk recorder as a first specific example of the information processing system 601.

In addition, in FIG. 10, portions which are relating to the present technology among constituent elements of a Blu-ray disk recorder 701 are mainly shown, and a part thereof is omitted. In addition, in the figure, portions corresponding to FIG. 8 are given with the same two-digit numbers from below, and portions having the same process are appropriately omitted, since descriptions thereof are repeated.

In the Blu-ray disk recorder 701, a flash memory 711 as a specific example of the non-volatile memory unit 611 of the information processing system 601 in FIG. 8 is adopted, and as a specific example of the main memory unit 613, a DRAM (Dynamic Random Access Memory) 713 is adopted. In addition, a hard disk drive (HDD) 721, a BD (Blu-ray disk) 722, a display 723, and a tuner 724 are added thereto.

In the flash memory 711, an operating system (OS), an executable file of an application program which is operated on the OS, a data file which is necessary when operating the application program, or the like are stored.

A data input-output unit 712 stores motion image data in which a program is recorded, or the like in the HDD 721, or the BD 722, or reads out the program from the HDD 721, or the BD 722.

The display 723 displays an operation screen, a set screen, or the like based on data which is supplied from the data input-output unit 712.

The tuner 724 receives a broadcasting signal of TV broadcasts, extracts motion image data from the received broadcast signal, and supplies the motion image data to the data input-output unit 712.

When the Blu-ray disk recorder 701 is initially started, an intermediate starting image is created, and is stored in the flash memory 711. Thereafter, an initial setting is performed by a user.

Subsequently, in the second starting, a prefetch profile PF is created after the intermediate starting image is developed in the DRAM 713. The prefetch profile PF is a profile for prefetching data which is necessary immediately after starting the Blu-ray disk recorder 701.

Subsequently, in the third starting, the prefetching is executed based on the prefetch profile PF after the intermediate starting image is developed in the DRAM 713, and the prefetched data is read out to the DRAM 713. In addition, data in which the prefetched data is added to the intermediate starting image is created as the final starting image, and is stored in the flash memory 711.

In addition, in the fourth starting and thereafter, the final starting image is developed in the flash memory 711.

Accordingly, when starting the Blu-ray disk recorder 701, it is possible to set the Blu-ray disk recorder 701 to a predetermined state rapidly, and to speed up operations after starting (more specifically, operations of a function which is executed by a program to be prefetched).

8. Second Specific Example of Second Embodiment

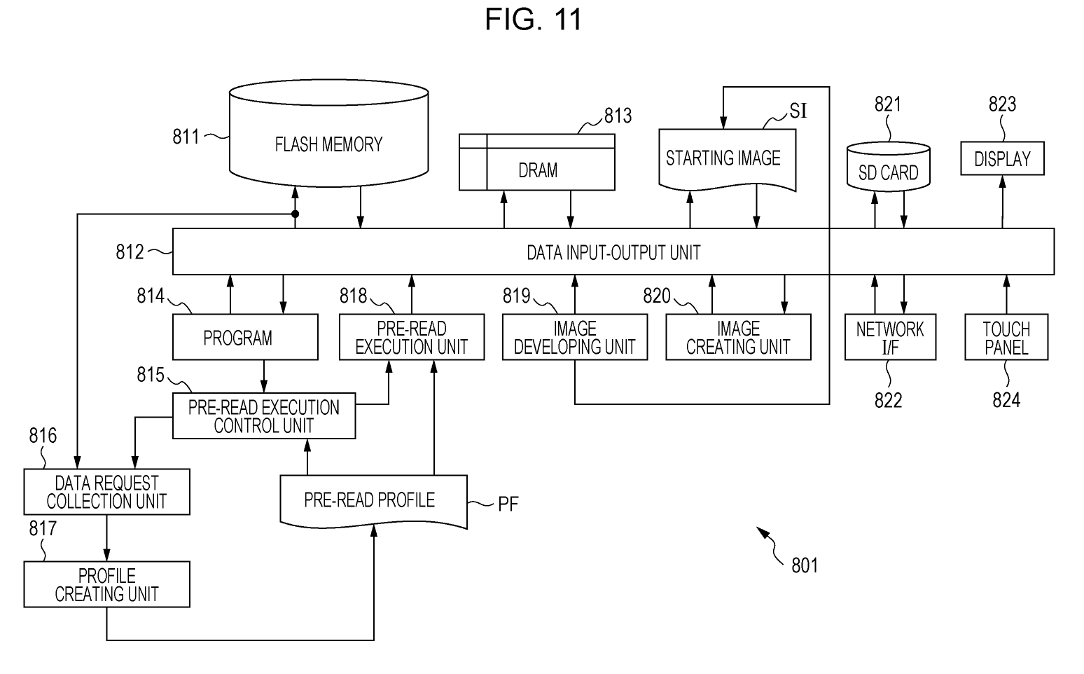

FIG. 11 is a block diagram which shows a configuration example of a function when the information processing system 601 is applied to a tablet terminal as a second specific example of the information processing system 601.

In addition, in FIG. 11, portions which are relating to the present technology among constituent elements of a tablet terminal 801 are mainly shown, and a part thereof is omitted. In addition, in the figure, portions corresponding to FIG. 8 are given with the same two-digit numbers from below, and portions having the same processing are appropriately omitted, since descriptions thereof are repeated.

In the tablet terminal 801, a flash memory 811 as a specific example of the non-volatile memory unit 611 of the information processing system 601 shown in FIG. 8 is adopted, and as a specific example of the main memory unit 613, a DRAM (Dynamic Random Access Memory) 813 is adopted. In addition, an SD card 821, a network interface (I/F) 822, a display 823, and a touch panel 824 are added thereto.

In the flash memory 811, an operating system (OS), an application program which provides a main service of the tablet terminal 801, a data file which is necessary when operating the application program, or the like are stored.

The SD card 821 is a storage medium in which an application program for causing the tablet terminal 801 to execute a predetermined function, or the like is stored. Reading/writing of the application program or the like with respect to the SD card 821 is performed by a data input-output unit 812.

The network I/F 822 is connected to an external device through a network, or a communication cable, and performs communication using a predetermined method. In addition, the network I/F 822 outputs data which is supplied from the data input-output unit 812 to the outside, or supplies data input from the outside to the data input-output unit 812.

The display 823 displays execution screens of an operation screen, a set screen, an execution screen of the application program, or the like, based on the data which is supplied from the data input-output unit 812.

The touch panel 824 is an operation device which performs a variety of operations of the tablet terminal 801. The touch panel 824 supplies an operation signal corresponding to operation contents to the data input-output unit 812.

In the tablet terminal 801, it is possible to download an application program from an external server, or the like, through the network I/F 822, and to preserve the application program in the flash memory 811, or the SD card 821. Along with an increase or decrease of the application program, data which is suitable for prefetching is also changed.

In contrast to this, the image creating unit 820 recreates the final starting image, and updates the image when there is a certain increase or decrease, or more with respect to the number of application programs when creating the final starting image.

In this manner, since the final starting image is updated, and is made adequate according to the change in the application program, it is possible to speed up operations after starting the tablet terminal 801 even when the application program is changed.

In addition, for example, it is preferable to update the final starting image not only when the application program is increased or decreased, but when other conditions are satisfied. For example, it is preferable to update the final starting image when a predetermined program (for example, an operating system, or the like) is updated, programs of a predetermined number or more (including the application program) are updated, or the like.

9. First Modification Example of Second Embodiment

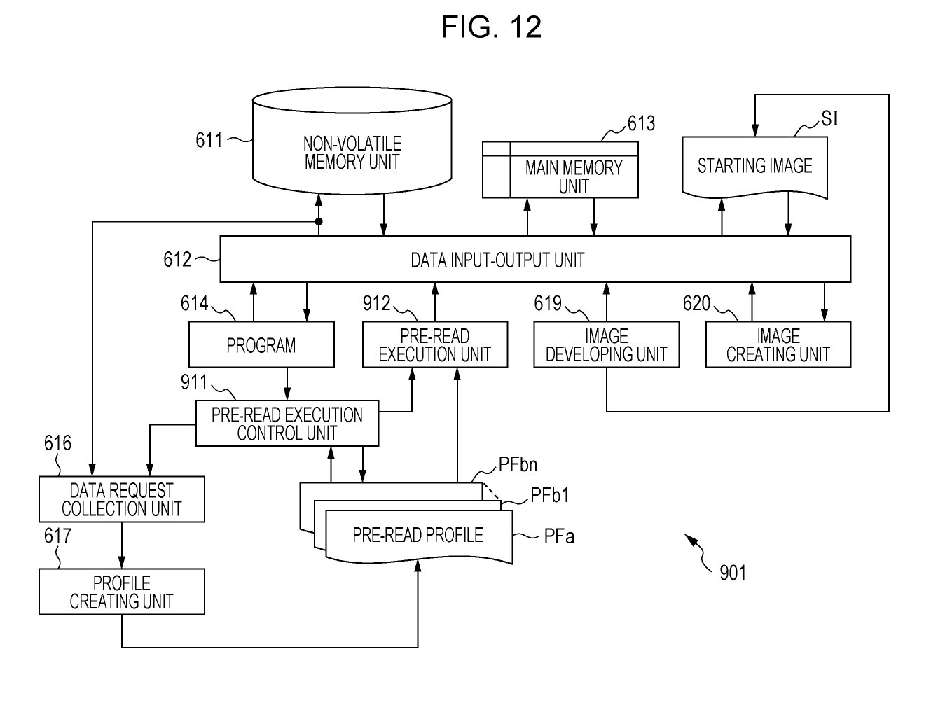

FIG. 12 is a block diagram which shows a configuration example of an information processing system 901 as a first modification example of the information processing system 601. The first modification example is an example in which the starting image SI is developed in the main memory unit 613, and prefetching can be further performed in each use case after starting the information processing system 901.

In addition, in the figure, portions corresponding to FIG. 8 are given with the same reference numerals, and portions having the same processing are appropriately omitted, since descriptions thereof are repeated.

The information processing system 901 is different from the information processing system 601 by being provided with a prefetch execution control unit 911, and a prefetch execution unit 912 instead of the prefetch execution control unit 615, and the prefetch execution unit 618 compared to the information processing system 601.

The prefetch execution control unit 911 instructs the data request collection unit 616 to collect a data request history with respect to a function which is executed in any use cases of the information processing system 901. A profile creating unit 617 creates a prefetch profile PFa based on the data request history.

In addition, the prefetch execution control unit 911 causes the data request collection unit to collect data request histories which are different from each other in each use case of the information processing system 901. The profile creating unit 617 creates prefetch profiles PFb1 to PFbn which are different from each other in each use case of the information processing system 901 based on each data request history.

In addition, the prefetch execution control unit 911 causes the prefetch execution unit 912 to perform the prefetching based on the prefetch profile PFa when creating the final starting image. Accordingly, prefetching data with respect to a function which is executed in any use case is included in the final starting image.

Accordingly, when starting the information processing system 901 after creating the final starting image, the final starting image including the prefetched data with respect to the function which can be executed in any use cases is developed in the main memory unit 613. In this manner, it is possible to rapidly operate the function which can be executed in any use cases after starting the information processing system 901.

In addition, the prefetch execution control unit 911 selects an appropriate prefetch profile among the prefetch profiles PFb1 to PFbn after the final starting image is developed in the main memory unit 613 according to a use case. In addition, the prefetch execution control unit 911 causes the prefetch execution unit 912 to perform the prefetching based on the selected prefetch profile. In this manner, it is possible to rapidly operate the function corresponding to the use case after starting the information processing system 901.

For example, when the information processing system 901 is a digital camera, a display function of a menu screen is assumed as a function which can be executed in any use cases. Accordingly, it is possible to rapidly display the menu screen by including the prefetched data with respect to the display function of the menu screen in the final starting image after starting the digital camera.

On the other hand, usually, use cases after starting are different depending on a starting method of a digital camera. A case will be studied in which, for example, a digital camera is started by opening a lens cover of the digital camera, or by operating a photograph reproducing button.

For example, when a digital camera is started by opening a lens cover, it is assumed that photographing is performed immediately after the starting. In this case, for example, it is possible to rapidly perform the photographing after starting the digital camera by performing prefetching based on a prefetch profile for a photographing function after developing the final starting image.

On the other hand, when the digital camera is started by operating the photograph reproducing button, reproducing of photograph data is performed thereafter. In this case, it is possible to rapidly perform the reproducing of photograph after starting the digital camera by performing prefetching based on a prefetch profile for an image viewer.

10. Second Modification Example of Second Embodiment

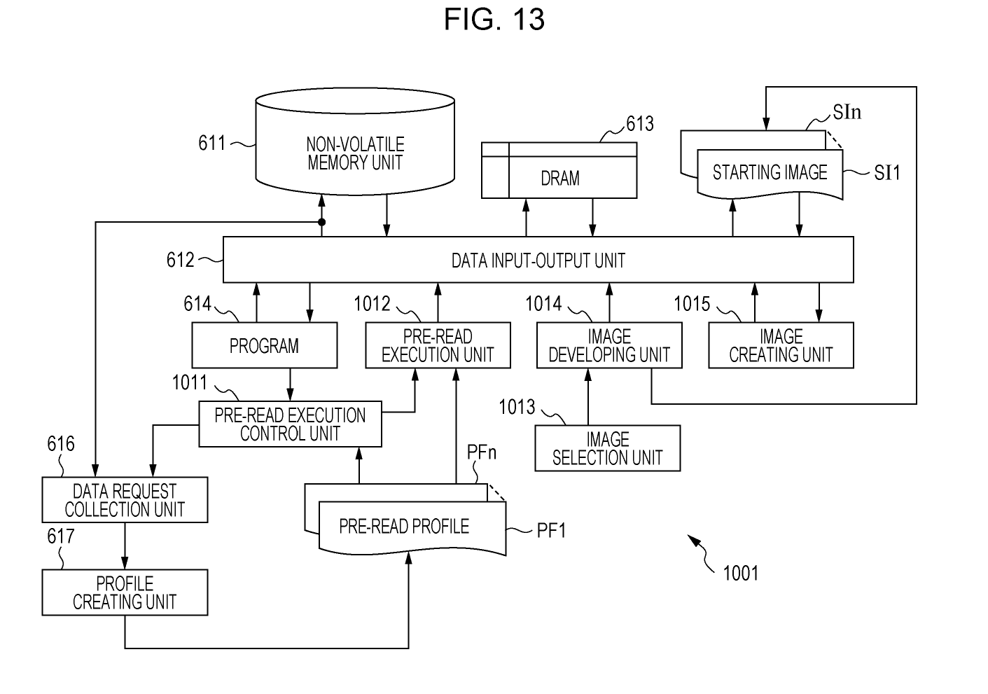

FIG. 13 is a block diagram which shows a configuration example of an information processing system 1001 as a second modification example of the information processing system 601. The second modification example is an example in which a plurality of starting image SI is created in each use case, and is used properly.

In addition, in the figure, portions corresponding to FIG. 8 are given with the same reference numerals, and portions having the same processing are appropriately omitted, since descriptions thereof are repeated.

The information processing system 1001 different from the information processing system 601 by being provided with a prefetch execution control unit 1011, a prefetch execution unit 1012, an image developing unit 1014, and an image creating unit 1015 instead of the prefetch execution control unit 615, the prefetch execution unit 618, the image developing unit 619, and the image creating unit 620 compared to the information processing system 601. In addition, an image selection unit 1013 is added to the information processing system 1001.

In addition, the information processing system 1001 can be started using a plurality of methods.

The prefetch execution control unit 1011 instructs the data request collection unit 616 to collect a data request history with respect to each starting method of the information processing system 1001. The profile creating unit 617 creates prefetch profiles PF1 to PFn based on the data request history.

In addition, the prefetch execution control unit 1011 selects a prefetch profile corresponding to the starting method of the information processing system 1001 at the time among the prefetch profiles PF1 to PFn when creating the final starting image. In addition, the prefetch execution control unit 1011 causes the prefetch execution unit 1012 to execute the prefetching based on the selected prefetch profile.

In addition, the image creating unit 1015 creates starting images SI1 to SIn which are different from each other in each starting method of the information processing system 1001. Accordingly, the starting images SI1 to SIn includes a common intermediate starting image, and prefetched data items which are different from each other in each starting method.

In addition, the image selection unit 1013 selects an appropriate starting image from among the starting images SI1 to SIn according to the starting method at the time of starting the information processing system 1001, and informs the image developing unit 1014 of the selected starting image. In addition, the image developing unit 1014 develops the starting image which is selected by the image selection unit 1013 in the main memory unit 613.

In this manner, an appropriate starting image according to the starting method of the information processing system 1001 is developed in the main memory unit 613.

For example, a case will be studied in which the information processing system 1001 is a Blu-ray disk recorder, and the Blu-ray disk recorder can be started by operating a power button, or a program table button.

For example, when the Blu-ray disk recorder is started by operating the power button, it is assumed that a menu screen is displayed after starting a function of viewing an broadcast. Accordingly, it is preferable to develop the starting image in the main memory unit 613 in a case where a starting image including prefetched data for the function of viewing the broadcast, and a function of displaying the menu screen is created, and the Blu-ray disk recorder is started by operating the power button. In this manner, it is possible to rapidly operate the function of viewing the broadcast, and the function of displaying the menu screen after starting the Blu-ray disk recorder by operating the power button.

On the other hand, when the Blu-ray disk recorder is started by operating the program table button, it is assumed that the program table is first displayed, and a recording reservation is made thereafter. Accordingly, when a starting image including prefetched data for a function of program table, and a function of recording reservation is created, and the Blu-ray disk recorder is started by operating the program table, it is preferable to develop the starting image in the main memory unit 613. In this manner, it is possible to rapidly make the recording reservation after starting the Blu-ray disk recorder by operating the program table button.

Further, it is also preferable that the prefetch execution control unit 1011, or the image selection unit 1013 learns a use state of a user after starting the information processing system 1001 in each starting method, and selects a function as a target of prefetched data which is included in each starting image, or a starting image to be used based on a result of learning.

For example, when it is learned that a rate of activating a function of an Internet moving picture is high after starting the Blu-ray disk recorder by operating the power button, a starting image including the prefetched data for the function of viewing the broadcast, and the function of Internet moving picture is created, and when the Blu-ray disk recorder is started using the same method, it is preferable that the starting image be developed in the main memory unit 613. In this manner, it is possible to rapidly operate the function of Internet moving picture after starting the Blu-ray disk recorder using the power button.

11. Other Modification Examples

Hereinafter, other modification examples than the modification example according to the above described embodiments of the present technology will be described.

A method of data prefetching is not particularly limited, and an arbitrary method can be adopted.

In addition, data which is not necessary immediately after starting the system may be, for example, prefetched before using the data during an operation of the system, similarly to a common prefetching method.

Configuration Example of Computer

The above described a series of processes that can be executed using hardware, or software. When the series of processes are executed using software, a program which configures the software is installed in a computer. Here, the computer includes a computer which is built into dedicated hardware, or, for example, a general-purpose personal computer which is able to perform various functions by installing various programs, or the like.

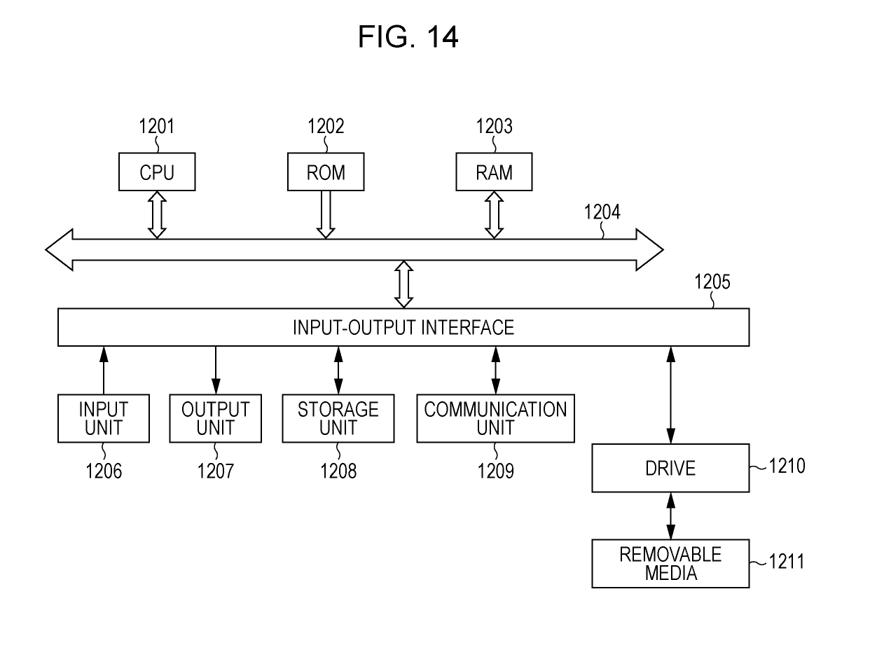

FIG. 14 is a block diagram which shows a configuration example of hardware of a computer which executes the above described series of processes using a program.

In the computer, a CPU (Central Processing Unit) 1201, a ROM (Read Only Memory) 1202, and a RAM (Random Access Memory) 1203 are connected to each other by a bus 1204.

The bus 1204 is further connected with an input-output interface 1205. The input-output interface 1205 is connected with an input unit 1206, an output unit 1207, a storage unit 1208, a communication unit 1209, and a drive 1210.

The input unit 1206 is configured by a keyboard, a mouse, a microphone, or the like. The output unit 1207 is configured by a display, a speaker, or the like. The storage unit 1208 is configured by a hard disk, a non-volatile memory, or the like. The communication unit 1209 is configured by a network interface, or the like. The drive 1210 drives a removable media 1211 such as a magnetic disk, an optical disk, a magneto-optical disk, a semiconductor memory, or the like.

In the computer which is configured as above, the CPU 1201 performs the above described series of processes, for example, by executing a program which is stored in the storage unit 1208 by loading to the RAM 1203 through the input-output interface 1205 and the bus 1204.

The program which is executed by the computer (CPU 1201) can be provided by being recorded in the removable media 1211, for example, as a package media, or the like.

In addition, the program can be provided through a wire, or a wireless transmission medium such as a local area network, the Internet, or digital satellite broadcasting.

In the computer, the program can be installed in the storage unit 1208 through the input-output interface 1205 by installing the removable media 1211 to the drive 1210. In addition, the program can be received in the communication unit 1209 through the wire, or wireless transmission medium, and can be installed in the storage unit 1208. In addition to that, the program can be installed in advance in the ROM 1202, or in the storage unit 1208.

In addition, the program to be executed by the computer may be a program of which processing is performed in time sequence in the order which is described in the specification, or may be a program of which processing is performed in parallel, or at necessary timing when a call is made, or the like.

In addition, in the specification, the system means a set of a plurality of constituent elements (device, module (component), or the like), and it is not important whether or not all of the constituent elements are in one same housing. Accordingly, the system includes any of a plurality of devices which is accommodated in a separate housing, and is connected through a network, and one device in which a plurality of modules is accommodated in one housing.

Further, the embodiments of the present technology are not limited to the above described embodiments, and various changes can be made without departing from the scope of the present technology.

For example, the present technology can adopt a configuration of cloud computing in which one function is processed in a plurality of devices by sharing, and in cooperation with each other through a network.

In addition, each step which is described in the above flowchart can be executed in one device, or in a plurality of devices by being shared.

Further, when a plurality of processes is included in one step, the plurality of processes which is included in one step can be executed in one device, or in a plurality of devices by being shared.

In addition, for example, the present technology can adopt the following configuration, as well.

(1) A memory management device which includes, a prefetch execution unit which performs prefetching of data from an auxiliary memory unit and moving the data to a main memory unit; and an initial data preservation unit which preserves data including at least a part of data items which are stored in the main memory unit before the prefetch execution unit performs the prefetching, and data including the data which is prefetched by the prefetch execution unit as initial data which is data placed in the main memory unit when a system including the auxiliary and main memory units is started, before the prefetch execution unit performs prefetching.

(2) The memory management device which is disclosed in (1) in which the prefetch execution unit performs the prefetching when the system is stopped, and the initial data includes data which is stored in the main memory unit when stopping the system, and the data which is prefetched by the prefetch execution unit.

(3) The memory management device which is disclosed in (2) in which the prefetch execution unit performs prefetching of data which is used in a function of executing the system after starting the system.

(4) The memory management device which is disclosed in (3) further includes a predicting unit which predicts a function which is executed after starting the system, in which the prefetch execution unit performs prefetching of data which is used in a function which is predicted by the predicting unit.

(5) The memory management device which is disclosed in (2) to (4) in which the initial data preservation unit preserves the initial data in the auxiliary memory unit, and a data reading-out unit which reads out, and moves the initial data to the main memory unit from the auxiliary memory unit, when starting the system, is further provided.

(6) The memory management device which is disclosed in (2) to (4) in which, the initial data preservation unit preserves the initial data in the main memory unit.

(7) The memory management device which is disclosed in (1) in which the prefetch execution unit performs the prefetching after starting the system, the initial data preservation unit preserves data including at least a part of data items which are stored in the main memory unit after starting the system, and data including the data which is prefetched by the prefetch execution unit as the initial data in the auxiliary memory unit, and a data reading-out unit which reads out, and moves the initial data to the main memory unit from the auxiliary memory unit, when starting the system, is further provided.

(8) The memory management device which is disclosed in (7) in which, when the initial data is not preserved in the auxiliary memory unit, the initial data preservation unit preserves at least a part of the data items which are preserved in the main memory unit after starting the system in the auxiliary memory unit as a first initial data, and when the first initial data is preserved in the auxiliary memory unit, and a second initial data is not preserved in the auxiliary memory unit, the prefetch execution unit performs the prefetching after starting the system, and the initial data preservation unit preserves data including the first initial data, and the data which is prefetched by the prefetch execution unit as the second initial data in the auxiliary memory unit.

(9) The memory management device which is disclosed in (7) or (8) in which the prefetch execution unit further performs prefetching of data corresponding to a starting method of the system after reading out, and moving the initial data to the main memory unit.

(10) The memory management device which is disclosed in (7) or (8) in which the prefetch execution unit performs prefetching of the data corresponding to a starting method of the system after starting the system, the initial data preservation unit preserves the initial data which is different in each starting method of the system, and the data reading-out unit reads out, and moves the initial data corresponding to the starting method of the system to the main memory unit from the auxiliary memory unit when starting the system.

(11) The memory management device which is disclosed in (7) to (10) in which the initial data preservation unit performs updating of the initial data when a program of executing the system is changed.

(12) A memory management method which includes, prefetching of data from an auxiliary memory unit, and moving the data to a main memory unit, and preserving data including at least a part of data items which are stored in the main memory unit before performing the prefetching, and prefetched data as initial data which is data stored in the main memory unit when starting a system which includes the auxiliary memory, and the main memory unit.

(13) A control program which causes a computer to execute processing including, prefetching data from an auxiliary memory unit and moving the data to a main memory unit, and preserving data including at least a part of data items which are stored in the main memory unit before performing the prefetching, and prefetched data as initial data which is data stored in the main memory unit when starting a system which includes the auxiliary memory, and the main memory unit.

(14) A computer readable recording medium on which the control program which is disclosed in (13) is recorded.

The present disclosure contains subject matter related to that disclosed in Japanese Priority Patent Application JP 2011-229575 filed in the Japan Patent Office on Oct. 19, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A memory management device comprising:
a prefetch execution unit which performs prefetching data from a first memory unit, and moving the data to a second memory unit; and
an initial data preservation unit which preserves data including at least a part of data items which are placed in the second memory unit before the prefetch execution unit performs the prefetching, and data including the data which is prefetched by the prefetch execution unit as initial data which is data stored in the second memory unit when a system including the first and second memory units is started, before the prefetch execution unit performs prefetching.

2. The memory management device according to claim 1,
wherein the prefetch execution unit performs the prefetching when the system is stopped, and
wherein the initial data includes data which is stored in the second memory unit when stopping the system, and the data which is prefetched by the prefetch execution unit.

3. The memory management device according to claim 2,
wherein the prefetch execution unit performs prefetching of data which is used in a function of executing the system after starting the system.

4. The memory management device according to claim 3, further comprising:
a predicting unit which predicts a function which is executed after starting the system,
wherein the prefetch execution unit performs prefetching of data which is used in a function which is predicted by the predicting unit.

5. The memory management device according to claim 2, further comprising:
a data reading-out unit which reads out, and moves the initial data to the second memory unit from the first memory unit, when starting the system,
wherein the initial data preservation unit preserves the initial data in the first memory unit.

6. The memory management device according to claim 2,
wherein, the initial data preservation unit preserves the initial data in the second memory unit.

7. The memory management device according to claim 1, further comprising:
a data reading-out unit which reads out, and moves the initial data to the second memory unit from the first memory unit, when starting the system,
wherein the prefetch execution unit performs the prefetching after starting the system, and
wherein the initial data preservation unit preserves data including at least a part of data items which are stored in the second memory unit after starting the system, and data including the data which is prefetched by the prefetch execution unit as the initial data in the first memory unit.

8. The memory management device according to claim 7,
wherein, when the initial data is not preserved in the first memory unit, the initial data preservation unit preserves at least a part of the data items which are preserved in the second memory unit after starting the system is preserved in the first memory unit as a first initial data,
wherein, when the first initial data is preserved in the first memory unit, and a second initial data is not preserved in the first memory unit, the prefetch execution unit performs the prefetching after starting the system, and
wherein the initial data preservation unit preserves data including the first initial data, and the data which is prefetched by the prefetch execution unit as the second initial data in the first memory unit.

9. The memory management device according to claim 7,
wherein the prefetch execution unit further performs prefetching of data corresponding to a starting method of the system after reading out, and moving the initial data to the second memory unit.

10. The memory management device according to claim 7,
wherein the prefetch execution unit performs prefetching of the data corresponding to a starting method of the system after starting the system,
wherein the initial data preservation unit preserves the initial data which is different in each starting method of the system, and
wherein the data reading-out unit reads out, and moves the initial data corresponding to the starting method of the system to the second memory unit from the first memory unit when starting the system.

11. The memory management device according to claim 7,
wherein the initial data preservation unit performs updating of the initial data when a program of executing the system is changed.

12. A memory management method comprising:
prefetching data from a first memory unit, and moving the data to a second memory unit; and
preserving data including at least a part of data items which are stored in the second memory unit before performing the prefetching, and prefetched data as initial data which is data stored in the second memory unit when starting a system which includes the first and second memory units.

13. A control program which causes a computer to execute processing, the processing comprising:
prefetching data from a first memory unit, and moving the data to a second memory unit; and
preserving data including at least a part of the data items which are stored in the second memory unit before performing the prefetching, and prefetched data as initial data which is data stored in the second memory unit when starting a system which includes the first and second memory units.

14. A computer readable recording medium on which the control program according to claim 13 is recorded.
